(19) United States
(12) Patent Application Publication
(10) Pub. No.: US 2009/0149783 A1
(43) Pub. Date: Jun. 11, 2009

(54) System And Method For A Cooperative Arm Therapy And Corresponding Rotation Module

(75) Inventors: Tobias Nef, Zuckenriet (CH); Robert Riener, Wangen (CH); Daniel Wegmann, Watt (CH); Gery Colombo, Uster (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Eidgenossische Technische Hochschule Zurich, Zurich (CH); Universitat zurich, Zurich (CH)

(21) Appl. No.: 11/792,035

(22) PCT Filed: Apr. 28, 2005
(86) PCT No.: PCT/CH2005/000236

§ 371 Date: Jul. 21, 2008

(30) Foreign Application Priority Data
Nov. 30, 2004 (EP) 04028310.3

(51) Int. Cl. A61H 1/02; A63B 21/00

(52) U.S. Cl. 601/5; 601/33

(57) ABSTRACT

A system for arm therapy of a user comprises a device for determining the position of the user, a first drive, an upper arm rotation module, an upper arm cuff, at least one hinge movably connecting the upper arm cuff and the first drive, a second drive, and a rotation drive provided on the upper arm rotation module itself. The upper arm cuff is connected to the arm of the user and has a substantially hollow-cylindrical shape when it is closed. The first drive and the second drive are adapted to place the upper arm rotation module in a defined spatial position, and the rotation drive is adapted to turn the upper arm cuff about its main axis relative to the outer part of the upper arm rotation module.

### TECHNICAL FIELD OF THE INVENTION

The invention relates to a system and a method for cooperative arm therapy, and to a corresponding rotation module.

### PRIOR ART

The prior art discloses a number of systems and methods that can improve the muscle strength and movement coordination of patients suffering from neurological deficits or from orthopedic impairments. Arm therapy also has positive effects in the treatment of stroke patients. Two types of robotic systems in particular are known from the prior art. On the one hand, there are therapeutic systems that are used mainly in hospitals and are thus shared between a number of patients. The second group involves systems that are intended for use at home and that assist an individual patient in his or her daily activities. These systems can be mounted on wheelchairs or tables, for example.

Known systems of these kinds can include passive, active and interactive systems. In passive systems, the limbs are stabilized only passively or are limited in their range of movement. In known systems such as those disclosed in U.S. Pat. No. 5,466,213 or U.S. Pat. No. 5,794,621, the arm is moved indirectly by means of the hand gripping a handle and the latter being moved by the system. These systems have the disadvantage that they record and transmit movements of the forearm and of the upper arm only in an indirectly coupled manner and therefore do not offer any direct guiding of the elbow joint. They move the hand only in the plane of the table and not three-dimensionally. Moreover, with these known systems, it is not possible to specifically train the upper arm or the forearm area.

These systems for arm therapy have a first drive that can be fixedly connected to the device determining the position of a user. The device determining the position of a user can be a chair with a backrest, which secures the back region, or can be a substantially horizontal surface on which the user lies down. The first drive can be arranged directly on this object or on a frame or such like connected to this object. In the abovementioned prior art, the first cuff to be connected to the arm of a user is a wrist cuff, the latter being connected to the first drive.

Starting out from this prior art, the object of the invention is to improve a system and a method of the type mentioned at the outset, in such a way that a greater number of degrees of freedom can be guided and supported.

### SUMMARY OF THE INVENTION

According to the invention, this object is achieved for a system with the characterizing features according to claim 1. A rotation module according to the invention is defined by the characterizing features of claim 6 or 7. A method according to the invention is defined by the characterizing features of claim 9.

By virtue of the fact that the system engages with a cuff on the upper arm, with force being transmitted via fixed arms, the upper arm can be completely guided. By means of a corresponding connection to the forearm, the elbow joint can be bridged and trained separately.

By virtue of the fact that the cuff is open to the side, the user can more easily introduce his or her arm into the device. This is especially useful for patients who are no longer able to (completely) bend their arm joints because of contractures (stiffened joints) or spasms.

In an advantageous embodiment, the rotation movements of the wrist (pronation/supination) can also be simulated, which is not possible in the known devices.

Further advantageous embodiments are characterized in the dependent claims.

### BRIEF DESCRIPTION OF THE FIGURES

The invention is now explained in greater detail on the basis of illustrative embodiments and with reference to the attached drawings, in which:

FIG. 1 shows a very schematic perspective view of the overall system according to the invention, together with a schematically depicted patient,

FIG. 2 shows a schematic exploded view of the main elements of the system according to FIG. 1,

FIG. 3 shows a perspective view of the system according to FIG. 1, seen from the closed side,

FIG. 4 shows a perspective view of the system according to FIG. 3 from another perspective,

FIG. 5 shows a schematic exploded view of the upper arm module,

FIG. 6 shows a schematic view of the upper arm module according to FIG. 5, seen from the open side,

FIG. 7 shows a perspective view of some exposed parts of the upper arm module, and

FIG. 8 shows a perspective bottom view of some exposed parts of the upper arm module.

### DETAILED DESCRIPTION OF THE PREFERRED ILLUSTRATIVE EMBODIMENTS

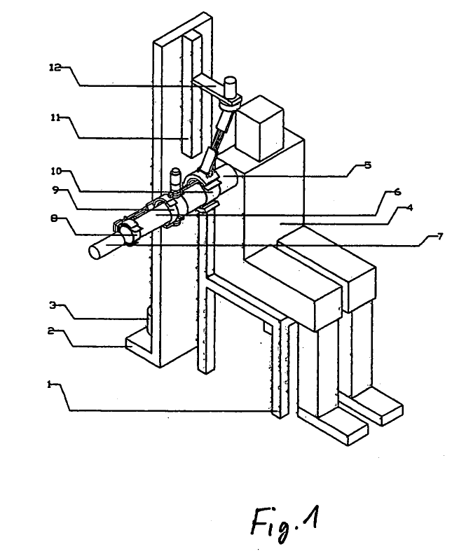

FIG. 1 shows a very schematic view of the system according to the invention, together with a schematically depicted patient 4. The patient 4 sits on a chair 1, which positions the patient 4 and in particular the shoulder of the patient. The backrest of the chair 1 is advantageously configured such that the shoulder is in a defined position, but at the same time the mobility of the shoulder and of the shoulder blade is not restricted. The chair 1 is here arranged in front of the frame and the robot support 2 in such a way that the right arm of the patient can be treated. It will be appreciated that a mirror-image configuration of the system, mounted on the left-hand side of a chair, can be provided for treating the left arm of the patient. An alternative solution for a device for a left arm is set out further below in the detailed description.

The robot support 2 is here a mobile element and can be mounted in particular on a chassis with wheels, such that the robot system can be easily displaced. A counterweight 3 that prevents tilting of the system is thus provided. The robot support is intended to receive the rail of a linear drive 11. It is of course also possible to secure the linear drive 11 directly on a wall, on a framework, etc. The linear drive 11 is intended to move a horizontally positioned jib 12 up and down in a vertically oriented plane. A simple solution of the linear drive 11 is a ball spindle, which is connected to the ship of the linear drive 11 and is driven by a motor. The ship of the linear drive 11 is, for example, mounted by ball bearings on a monorail. The horizontal jib 12, in this case arranged perpendicular to the framework 2 and thus to the axis of the linear drive 11, connects the ship of the linear drive 11 to the orthosis 16-23, 28-37 and 38-52, that is to say to the following elements: upper arm rotation module, elbow rotation module, forearm rotation module, and connecting pieces. These parts can be made of aluminum, for example, in order to reduce their weight while at the same time ensuring sufficient stiffness.

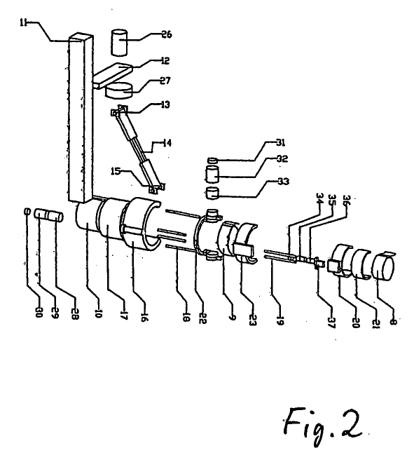

FIG. 2 shows in more detail the elements that are connected to the jib and that guide the upper arm 5 of the patient 4 and the forearm 6 of the patient 4. The hand 7 (or wrist) shown schematically in FIG. 1 is freely movable. However, it is also possible to provide a handle (not shown in the drawings) connected to the forearm orthosis. An upper arm cuff 10 connects the upper arm 5 of the patient 4 to the orthosis; the forearm cuff 9 connects the forearm 6 of the patient 4 to the orthosis, and the wrist cuff 8 connects the part of the patient's forearm 6 near the wrist to the orthosis. All the cuffs are advantageously made of a skin-compatible material and can be pulled tight preferably with the aid of a velcro-type closure. A cuff is understood as any customary securing element with which part of an arm, or an article of clothing surrounding an arm, can be fixed to another object.

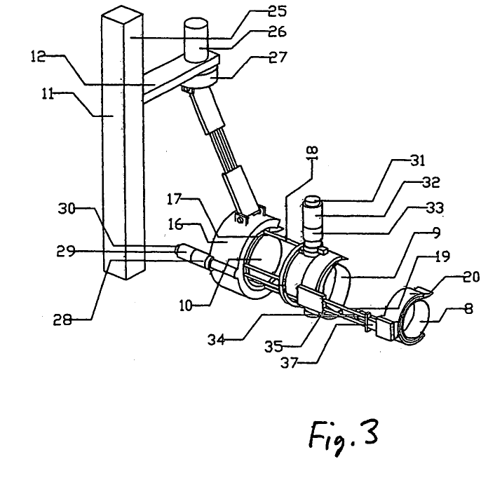

FIG. 2 now shows, in an exploded schematic view, the other mechanical features of the system according to the invention. The same features in all the figures are identified by the same reference numbers. The jib 12 is secured on the vertical linear drive 11, and a second drive 26 is mounted on the jib 12. This second drive 26 with vertical axis of rotation permits the rotation of the patient's arm in the horizontal plane. The now schematically depicted second drive 26 is usually composed of a DC motor, a digital encoder, and a “harmonic drive” gear that is free of backlash. The use of other drives is also possible, for example brushless direct-current motors and planetary gears. Its main axis arranged parallel to the spindle of the linear drive 11 is connected to a force sensor 27 that measures six degrees of freedom. This force sensor, in brief a 6-DOF force sensor 27, measures the forces and torques that occur and sends the detected signals to control electronics. This means that the force sensor 27 also measures the horizontal force with which the first drive 25 (see FIG. 3) drives the ball spindle, which can be a commercially available DC motor encoder and a ball spindle drive. The reference number 25 designates the drive located in the linear module 11. The force sensor 27 also measures the torque delivered by the second drive 26 and, after a transformation of coordinates, the torque delivered by the third drive 29, as will be explained in more detail below. The force sensor 27 can be designed, for example, as a system of several strain gauges for all six axes.

The second drive 26, coupled via the force sensor 27, drives the upper supporting connection 13. The upper supporting connection 13 connects a supporting connection 14 to the force sensor 27. The supporting connection 14 can rotate freely about the horizontal axis, corresponding to a passive degree of freedom. The supporting connection 13 can be formed by a shaft mounted on two ball bearings.

The supporting connection 14 connects the upper arm rotation module, in particular the outer half-cylinder 16 thereof, to the force sensor 27. A supporting connection 14 made of aluminum is again advantageously chosen for reasons relating to the weight of the material and its stiffness. The supporting connection 14 preferably has a length adjustment mechanism (not shown in the drawings), which permits a length adjustment of the supporting connection, such that the system can easily be used for patients 4 with different arm. lengths. As in the illustrative embodiment depicted here, the supporting connection 14 can be composed of three round rods, which can be recessed to a greater or lesser extent into the aluminum body (top and bottom) of the supporting connection 14.

The lower supporting connection 15 connects the supporting connection 14 to the upper arm rotation module and, like the upper supporting connection 13, is advantageously composed of a shaft mounted on two ball bearings. In functional terms, this is a hinge joint obtained with the aid of two ball joints.

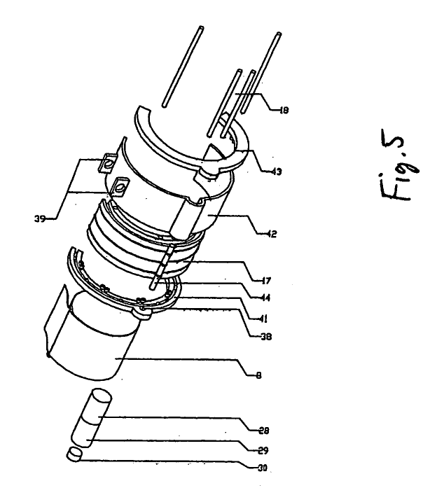

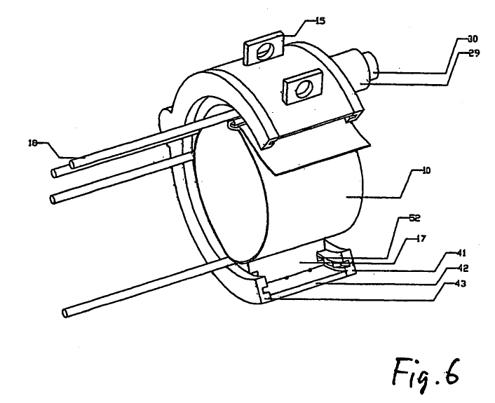

The upper arm rotation module is formed in particular by an outer half-cylinder 16 and an inner half-cylinder 17, the function of which will be explained in more detail with reference to FIG. 5 and FIG. 6. A connecting rail 18 connects the upper arm rotation module 16, 17 to the fourth drive 32, namely the elbow drive. The connecting rail 18 is here composed of four round rods, which are arranged at irregular intervals through ca. 180 degrees about the hollow space defined by the half-cylinders 16 and 17.

A third drive 29 is arranged on the outer half-cylinder 16, parallel to said connecting rail 18. A torque sensor 28 is arranged in front of said third drive 29, and an encoder 30 for the third axis is arranged behind it. The encoders mentioned here for the various axes serve as signal transmitters for the control electronics for establishing the position and for feedback and control of the drives. The torque sensor 28 of the third axis measures the torque delivered by the third drive 29 and is advantageously formed by a strain gauge. The third drive 29 delivers the torque for an internal and external shoulder rotation, as will be explained below. The third encoder 30 measures the position of the third axis and is advantageously an optical encoder.

The connecting rail 18 from the upper arm to the elbow is fitted into the elbow half-cylinder 22 which is located near the upper arm and on which there is a fourth drive 32 with a torque sensor 33 for the fourth axis and with an encoder 31 for the fourth axis. The axis of rotation of this drive, crosses the axis of symmetry of the upper arm rotation module centrally and at right angles. The forearm cuff 9 is secured on the half-cylinder 23 of the elbow located near the wrist and engaging in said elbow half-cylinder 22 near the upper arm. The half-cylinder 23 near the upper arm is connected via the connecting rail 19 and via the torque sensor 37 to the outer half-cylinder 20 of the forearm rotation module.

The forearm rotation module is composed of the inner cylinder 21, which rotates in the outer half-cylinder 20 and thus permits the pronation/supination of the forearm. For this purpose, a fifth drive 35 is provided on the outer half-cylinder 20 and forms a unit together with a torque sensor 36 of the fifth axis and with a fifth encoder 34.

The torque of the fifth drive 35 can be measured redundantly both with the torque sensor 36 and also with the torque sensor 37. The sensor 27 measures the torques of the drives 25, 26 and 29.

FIG. 3 now shows an illustrative embodiment of an assembled system according to the invention in a schematic perspective view. The linear drive 11 contains the first drive 25 that drives the ball spindle (not shown) with which the jib 12 is moved up and down. It will be seen from FIG. 3 that, by means of the second drive 26, the outer cylinder 16 of the upper arm rotation module can be arranged, by simultaneous vertical adjustment by the jib 12, in any desired orientation and height with respect to the position of the linear drive 11 and also with respect to a seated patient. The torque for the internal and external shoulder rotation is delivered by the third drive 29. The connecting rail 18 thus turns with the elbow joint, which is then turned by the third drive 32 for flexion and extension of the elbow. With the wrist cuff 8 which is provided in the area of the arm joint and which is connected to the elbow via the forearm rotation module 20/21 and the forearm connecting rail 19, the forearm retained by the cuff 9 is prepared for pronation/supination of the forearm, which can be effected by the drive 35 as a relative movement of the cuffs 8 and 9 with respect to one another. The forearm rotation module 20/21 is advantageously slightly smaller and lighter than but otherwise identical to the upper arm rotation module 16/17, such that the description regarding FIGS. 5 to 7 also applies to the forearm rotation module 20/21.

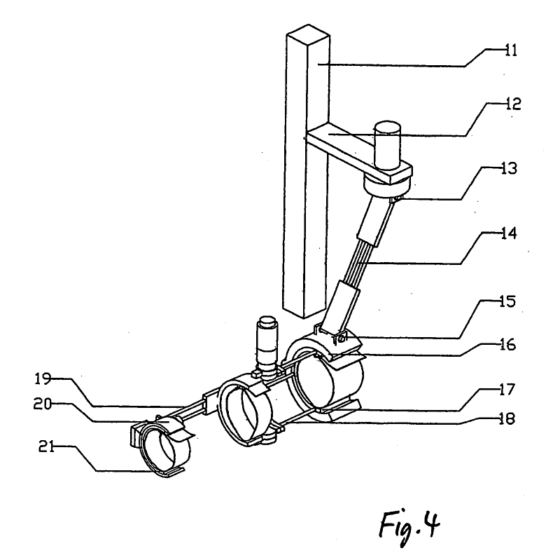

The object depicted in FIG. 3 is shown from the opposite side in FIG. 4, thus very clearly illustrating the laterally open rotation modules 16/17, 20/21 and 22/23 in the rest position. It will be clear that, even if the patient 4 has limited mobility, he or she can still easily introduce the arm sideways into the system.

FIG. 5 now shows an exploded view of the upper arm module. The forearm rotation module can be realized in the same way, only the dimensions are advantageously slightly smaller and, instead of rails 18 or supporting connection eyelets 39, is now provided with the rail 19 and the receiver for the rails 18. A simple rotation movement of the elbow about its axis is also permitted via a direct drive 32.

As has been stated, the upper arm rotation module is composed of an outer half-cylinder 16 and of an inner half-cylinder 17. The outer half-cylinder 16 is composed of a central retaining wall 42 on which two eyelets 39 are provided for securing the lower supporting connection 15. The retaining wall 42 positions the outer walls 41 and 43 of the upper arm rotation module that are each placed laterally on the wall 42. The motor-side outer wall of the upper arm rotation module is provided with an opening 38 for the shaft of the drive 29, which drives the cables, of which there are in this case three 45, 46 and 47, via the cable drive flange 44. The cable drive flange can, for example, be an aluminum pin roughened by sandblasting. The drive cables 45, 46 and 47 transmit the rotation movement of the cable drive flange 44 to the inner half-cylinder 17 of the upper arm rotation module.

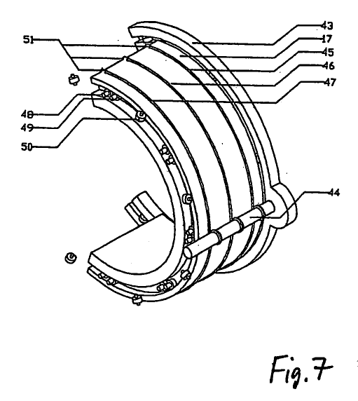

The pretensioning of the cable can be regulated by a setting screw (not shown here). To achieve the greatest possible step-down ratio, several cables are used, in this case three. In this way, the load is distributed among these three cables, and it is possible to use thinner cables 45, 46 and 47 with smaller bending radii. A greater step-down ratio can thus be achieved, which is calculated from the ratio between the external diameter of the inner half-cylinder 17 of the upper arm rotation module and the external diameter of the cable drive flange 44. On the motor side, that is to say on the left in FIG. 5, the inner half-cylinder 17 of the upper arm rotation module engages in the ball bearing, as can be seen more clearly from FIG. 7. The distal side of the inner half-cylinder 17 of the upper arm rotation module is provided with openings for receiving said connecting rail 18 from the upper arm to the elbow. It is clear that, instead of the rod-guiding connecting rail 18, a half hollow-cylindrical solid material can also be used, which can also be a continuation of the cylinder of the upper arm rotation module open on one side.

Instead of the cables 45, 46, 47 shown here and secured on the outer surface of the inner cylinder 17, they can also each be secured on the inside wall of the outer cylinder 16. The cable drive flange 44 is then secured on a drive that is secured on the inner hollow-cylinder part 17.

In another embodiment, it is also possible to have two pairs of cables lying opposite one another (in other words two halves 46), in which case, when the flange 44 is turned in one direction, one cable is wound up and the diametrally opposite cable unwound; the flange 44 then works as a roller. The module shown in the illustrative embodiments has the advantage, however, that the wire can be more easily guided in the small space between the hollow-cylinder parts 16 and 17 and does not have to be wound up on the flange 44.

In another embodiment not shown in the drawings, the cables 45 to 47 can also be replaced by a V-belt. The V-belt is secured in the area of the ends of the hollow cylinder 17. The V-belt has knobs and is guided round the drive flange, which also has knobs and ensures a clearance-free contact with the belt.

Finally, it is also possible in principle to provide a curved toothed rod, which is arranged on the cylinder and into which a suitably driven toothed wheel or spindle engages.

FIG. 6 shows the upper arm rotation module from the open side. It can clearly be seen that the cuff 10 is secured on the inner cylinder 17, which is held laterally by the motor-side outer wall 41 and the distal outer wall 42.

The devices shown here are each provided for training the right arm of a user 4. If the opening of the cuff 8 of the upper arm rotation module is directed downward, it is necessary simply to switch the elbow drive and the forearm rotation module and change the handle to a left hand. If the cuff 8 of the upper arm rotation module has a lateral opening, it is also possible alternatively for the upper arm rotation module to be rotated through 180 degrees along the axis of the upper arm.

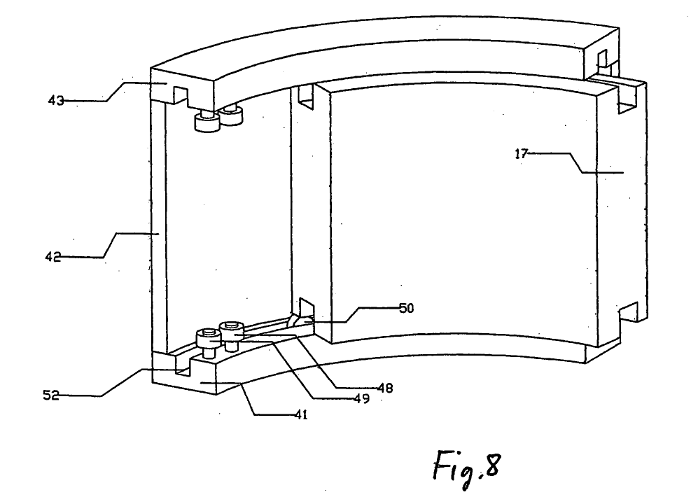

FIG. 7 now shows, in a partially dismantled perspective view of the upper arm rotation module, a more exact representation of the drive of the inner half-cylinder. FIG. 8, finally, shows a perspective bottom view of the upper arm rotation module. The first, second and third drive cables 45, 46 and 47 are clamped at respective anchor points 51. A similar anchoring is provided at the opposite end of the inner half-cylinder 17. The cables 45, 46 and 47 then run over and around the cable drive flange 44 to said second attachment. The cable drive flange 44 protrudes through a bearing in the distal outer wall. 43 of the upper arm rotation module and is driven from the opposite side.

The schematic view shows some of the ten inner ball bearings 48 and some of the ten outer ball bearings 49. There are also twelve lateral ball bearings 50. The lateral ball bearings 50 are in contact with the polished outer edge of the inner half-cylinder 17. In this way they guide the half-cylinder 17. Depending on the position of the inner half-cylinder 17, four or five ball bearings have contact. The ball bearings 48 and 49 lie on the outer end of steel pins, while the other end is inserted and fixed into the respective outer wall 41, 43 of the upper arm rotation module. The ball bearings 50 are likewise held by steel pins. The ball bearings lie in the center of the steel pins which, at both ends, are connected to the respective outer wall 41, 42 of the upper arm rotation module by means of screws that lie perpendicular to the steel pin. The steel pins thus come to lie parallel to the outer wall. Cuttings are formed in the outer wall to allow the ball bearings to turn freely. These ball bearings 50 are held by steel pins that are fixed on the inside face of the respective outer wall 41, 43 of the upper arm rotation module.

Completely conventional types of ball bearings can be used. These ball bearings 50, together with the inner and outer ball bearings 48 and 49, determine the position of the inner half-cylinder 17. The combination of ball bearings limits the movement of the inner half cylinder 17 to a rotation about the center of the half-cylinder 17. During this rotation, there is no sliding friction, but only a rolling friction in the ball bearings 48, 49 and 50. The ball bearings 48 are each mounted on a steel pin, which is fixed on the outer wall 41, 43. The ball bearings 49 are mounted such that they can be easily displaced relative to the inner ball bearing 48. Both ball bearings 48 and 49 are mounted inside the side slit 52 of the half-cylinder 17, which can be clearly seen in FIG. 6. The inner ball bearings 48 are in contact with that edge of the slit 52 nearer the center, and the outer ball bearings 49 are in contact with that edge of the slit 52 further away from the center.

It will be clear from the description that the rotation module with the inner half-cylinder 17 and outer half-cylinder 18 is statically overdetermined. For this reason, the individual components have to be produced with a high degree of precision. In other embodiments of the invention, it is also possible to have fewer ball bearings, such that the system is not overdetermined, or the ball bearings can be mounted resiliently if the spring forces are greater than the externally applied bearing loads.

The term half-cylinder in this context does not mean a half cylinder that covers a spatial angle of 180 degrees. The term half-cylinder here means a hollow rotation body which has a substantially cylindrical jacket and which covers an angle of between 130 and 210 degrees. The securing of the cable arrangement permits at most one rotation about this angle minus the angle range necessary for the mounting of the cables. Since this differs depending on the module (upper arm/elbow/wrist), a movement angle for a rotation in the range of approximately 110 to 190 degrees can be covered. The unit can also be designated as a hollow-cylinder part element.

Although the principle of the components described here is to some extent known from the sensors and robots used in industrial robot technology, the features presented here are of a different scope, particularly since they have to comply with medical regulations when used on patients.

The most important elements of the solution of the system are that the distal part of the system is constructed as an exoskeleton. The patient's arm is connected to the system at exactly three places with biocompatible cuffs 8, 9 and 10. The version described in the illustrative embodiment presented here comprises five actuated degrees of freedom (four without actuated forearm cuff) and permits flexion and extension of the elbow joint and spatial shoulder movements about three degrees of freedom. It also permits pronation/supination of the wrist 7.

The advantage of the ball bearings 48, 49 and 50 is not only the smooth and clearance-free rotation of the inner half-cylinder 17 in the outer half-cylinder 18, but also the fact that they take up the tilting movements caused by the orthosis by its free movement in space with correspondingly long lever arms from the center of the forearm (eyelets 39) to the attachment in the area of the wrist 7, such that basically only rolling friction occurs.

There are basically two technical possibilities for producing the inner cylinder and outer cylinder 16/17; 20/21; 22/23, that is to say the fundamental hollow rotation body. One possibility is the turning of a full cylinder, which is then cut open. In the illustrative embodiment presented here, the rotation body has by contrast been milled from a block, since the rotation body, in the case of cutting open a full cylinder after it has been turned to its dimensions, can change in shape because of possible stresses in the original aluminum block. A suitable milling machine has a precision of one micron. The optimal width of the groove 52 for the ball bearings was then approximated in small milling steps.

The advantage of the system according to the invention is that it can move the shoulder, approximated through three rotatory degrees of freedom, and the elbow, approximated through one rotatory degree of freedom, directly and without restriction. A further degree of freedom is afforded by the pronation/supination of the forearm. The illustrative embodiment according to the invention has a low inertia, little friction and minimal play. The actuators are advantageously able to reach the hand of the patient 4 with a tangential speed of up to 1 meter per second, thus applying an acceleration of approximately gravitational acceleration both in acceleration and also in braking.

The linear drive 11 with the first axis and with the first drive 25 permits the abduction and adduction of the shoulder. The rotation of the shoulder in the horizontal plane is realized with a second rotation drive 26. This drive 26 is connected directly to the ship of the linear drive 11. The rotation module has a third drive 29 and permits the internal and external shoulder rotation, since it is connected by a cuff 10 to the upper arm of the patient 4. The elbow flexion and elbow extension are ensured by means of a fourth rotation drive 32, with a cuff 9 being connected to the elbow area of the patient 4. Finally, the pronation/supination is permitted by means of a fifth rotation drive 35, with a cuff 8 being connected to the wrist area 7 of the patient 4.

By virtue of the two non-actuated degrees of freedom, the system is statically determined only in combination with the patient's arm when the orthosis is connected to the linear module 11. Thus, pretensioning between the robot and the patient's arm can be effectively ruled out.

Two control types can be provided in particular. For example, any desired free movement of the patient's arm can be permitted, recorded and stored, in which case the respective encoders of the different drives record the axis position and store it in a memory unit. It is thus possible, by direct control of the relevant drives according to the stored encoder positions, to repeat a previously executed movement completely and identically. It is also possible, by moving a patient's arm, to record its existing mobility and store this as a limit value for a movement program.

It is possible to provide for each user a so-called patient-cooperative control. In such a setup, impedance and admittance control principles are used as a basis for detecting the existing voluntomotoricity of the patient and taking this into consideration in the movement calculation. This means that the effort by the patient to follow a movement predefined by the control is taken into account by the fact that the corresponding actuators help the user less to complete the movement.

For this patient-cooperative control, the sensor signals of the position sensors and of the force sensors are evaluated. By means of the data signals of the sensors, it is possible for the control electronics to provide a feed-back controlled movement. It is advantageous in particular to provide a screen with a display for presenting an image of the arm of the patient 4, such that start points and target points can be shown in order to convert, with the control electronics, the read-out encoder signals into a corresponding image display.

It is clear that various changes and modifications can be made to the device and to the proposed method, without thereby departing from the scope of the present invention as set forth in the attached patent claims.

### LIST OF REFERENCE NUMBERS

1 chair

2 robot support

3 counterweight

4 patient

5 patient's upper arm

6 patient's forearm

7 patient's hand

8 wrist cuff

9 forearm cuff

10 upper arm cuff

11 linear drive

12 jib

13 upper supporting connection

14 supporting connection

15 lower supporting connection

16 outer half-cylinder of upper arm rotation module

17 inner half-cylinder of upper arm rotation module

18 connecting rail—upper arm to elbow

19 connecting rail—elbow to forearm

20 outer half-cylinder of forearm rotation module

21 inner half-cylinder of forearm rotation module

22 half-cylinder of elbow rotation module near upper arm

23 half-cylinder of elbow rotation module near wrist

25 drive module with first drive

26 second drive

27 6-DOF force sensor

28 torque sensor of third axis

29 third drive

30 encoder of third axis

31 encoder of fourth axis

32 fourth drive

33 torque sensor of fourth axis

34 encoder of fifth axis

35 fifth drive

36 torque sensor of fifth axis

37 further torque sensor of fifth axis

38 opening

39 eyelet

41 motor-side outer wall of upper arm rotation module

42 side wall of upper arm rotation module

43 distal outer wall of upper arm rotation module

44 cable drive flange

45 first drive cable

46 second drive cable

47 third drive cable

48 inner ball bearing

49 outer ball bearing

50 lateral ball bearing

51 anchor point

52 side slit

1-11. (canceled)

12. A system for arm therapy of a user, comprising:
a device determining the position of the user;
a first drive capable of being fixedly connected to the device determining the position of the user;
an upper arm rotation module having an inner part and an outer part;
an upper arm cuff secured on the inner part of the upper arm rotation module;
at least one hinge movably connecting the upper arm cuff and the first drive;
a second drive capable of being articulated on the outer part of the upper arm rotation module; and,
a rotation drive being provided on the upper arm rotation module itself,
wherein the upper arm cuff is connected to the arm of the user,
wherein the upper arm cuff has a substantially hollow-cylindrical shape when closed,
wherein the first drive and the second drive are adapted to place the upper arm rotation module in a defined spatial position, and
wherein the rotation drive is adapted to turn the upper arm cuff about its main axis relative to the outer part of the upper arm rotation module.

13. The system as claimed in claim 12, further comprising control electronics connected with the first drive, the second drive and the rotation drive, the control electronics being adapted to generate control signals for the first and second drives to place the upper arm rotation module in a spatially defined position and to generate additional control signals for the rotation drive to turn the upper arm cuff about its main axis relative to the outer part of the upper arm rotation module.

14. The system as claimed in claim 12, further comprising:
first connecting elements of the inner part of the upper arm rotation module secured to the upper arm cuff;
an elbow cuff;
an elbow rotation module having a part near the upper arm of a user and a part which is near the wrist of a user; and
a hinge adjustably connecting the part near the upper arm and the part near the wrist to one another,
wherein the first connecting elements secure the upper arm rotation module to the part of the elbow rotation module near the upper arm,
wherein the part of the elbow rotation module which is near the upper arm is connected to the elbow cuff, and
wherein the axis of the hinge coincides with the elbow axis of an inserted arm of a user.

15. The system as claimed in claim 14, wherein a further rotation drive is provided to drive the hinge axis.

16. The system as claimed in claim 15, comprising control electronics connected with the first drive, the second drive, the rotation drive and the further rotation drive, the control electronics being adapted to generate control signals for the first and second drives to place the upper arm rotation module in a spatially defined position, to generate additional control signals for the rotation drive to turn the upper arm cuff about its main axis relative to the outer part of the upper arm rotation module and to generate further additional control signals for the further rotation drive on the elbow rotation module to turn the elbow cuff transverse to its main axis relative to the axis of the upper arm rotation module.

17. The system as claimed in claim 14, further comprising:
second connecting elements of the part of the elbow rotation module near the wrist;
a wrist cuff; and
a wrist rotation module having an inner part connected to the wrist cuff and an outer part,
wherein the second connecting elements secure the elbow rotation module on the outer part of the wrist rotation module, and
wherein the outer part and the inner part of the wrist rotation module being connected so as to be pivotable relative to one another.

18. The system as claimed in claim 17, wherein an additional rotation drive is provided on the wrist rotation module itself such that the wrist cuff turns about its main axis relative to the outer part of the wrist rotation module, the wrist cuff being arranged on the inside and having a substantially hollow-cylindrical shape when closed.

19. The system as claimed in claim 18, further comprising control electronics connected with the first drive, the second drive, the rotation drive, the further rotation drive and the additional rotation drive, the control electronics being adapted to generate control signals for the first and second drives to place the upper arm rotation module in a spatially defined position, to generate additional control signals for the rotation drive to turn the upper arm cuff about its main axis relative to the outer part of the upper arm rotation module, to generate further additional control signals for the further rotation drive on the elbow rotation module to turn the elbow cuff transverse to its main axis relative to the axis of the upper arm rotation module, and to generate further additional control signals for the additional rotation drive to turn the wrist cuff about its main axis relative to the outer part of the wrist rotation module.

20. The system as claimed in claim 12, wherein the rotation module has a lateral opening of a size such that the associated arm part of a user can be introduced from the side into the corresponding cuff.

21. The system as claimed in claim 17, wherein all rotation modules have a lateral opening of a size such that the associated arm part of a user can be introduced from the side into the corresponding cuff.

22. The system as claimed in claim 12, wherein one or more of the drives each has a signal transmitter for determining the axis position of the drives.

23. The system as claimed in claim 22, wherein the signal transmitters are adapted to transmit position signals, angle signals, force signals and torque signals to control electronics in order to define repetitive movements, to record the repetitive movements, or to generate corresponding control signals for the drives.

24. A rotation module for a system for arm therapy of a user, comprising:
a cuff having a substantially hollow-cylindrical shape when closed;
an inner hollow-cylinder element part connected to a correspondingly associated cuff;
an outer hollow-cylinder element part;
a drive train or a toothed wheel; and
at least one drive means from the group of a cable, a V-belt or a gear rim, said at least one drive means being fixed on one of the two hollow-cylinder element parts at an angular distance from one another and guided between the inner surface of the outer hollow-cylinder element part and the outer surface of the inner hollow-cylinder element part about the drive train or engaging with the toothed wheel, such that the cuff turns about its main axis relative to the outer part of the rotation module.

25. A rotation module for a system for arm therapy of a user, comprising:
a cuff having a substantially hollow-cylindrical shape when closed;
an inner hollow-cylinder element part connected to a corresponding cuff;
an outer hollow-cylinder element part having end-pieces; and
two lateral guides provided in the end-pieces and having corresponding radial ball bearings,
wherein the inner hollow-cylinder element part is guided in the two lateral guides.

26. The rotation module according to claim 25, further comprising additional radial ball bearings capable of supporting the inner hollow-cylinder element part against the end-pieces.

27. The rotation module as claimed in claim 24, further comprising a lateral opening of a size such that the associated arm part of a user can be introduced from the side into the corresponding cuff.
